(19) United States
(12) Patent Application Publication
(10) Pub. No.: US 2007/0244903 A1
(43) Pub. Date: Oct. 18, 2007

(54) Collectively managing media bookmarks

(76) Inventors: Emily J. Ratliff, Austin, TX (US); Loulwa F. Salem, Austin, TX (US); Kimberly D. Simon, Austin, TX (US)

Correspondence Address: IBM CORP (AP);C/O AMY PATTILLO, P. O. BOX 161327, AUSTIN, TX, 78716, US

(21) Appl. No.: 11/406,182

(22) Filed: Apr. 18, 2006

(51) Int. Cl. G06F 17/30

(52) U.S. Cl. 707/10

(57) ABSTRACT

A method, system, and program are provided for collectively managing media bookmarks. A bookmark management system uploads user specified bookmarks designating play locations with media items from media systems and stores the bookmarks in a searchable database. The bookmark management system stores bookmarks in the searchable database according to at least one bookmark attribute. Media systems may search the searchable database of the bookmark management system according bookmark attributes and request downloads of the stored bookmarks. The bookmark management system downloads selected bookmarks to requesting media system, wherein the requesting media system enables play of a media item associated with the downloaded bookmarks from the searchable playback locations specified in the bookmarks.

### BACKGROUND OF THE INVENTION

1. Technical Field

The present invention relates in general to media bookmark management and in particular to managing uploading and downloading of media bookmarks across multiple media systems enabled to control playback of media items from searchable playback locations specified in bookmarks.

2. Description of the Related Art

Consumers continue to gain access to more and more types of digital media, including video, audio, multi-media presentation, flash presentation, and others, through many types of computing systems, including laptop computer systems, stand-alone digital video disc (DVD) players, digital video records, digital telephony systems, and many other systems that provide “players” for playing different types of digital media.

To aid a consumer in organizing information, some DVD players provide an option for a user, while watching a digital video, to press a button or enter other input and set a “bookmark” at a particular time location within the digital video. Since most digital videos have a fixed play time, the time location represented by the bookmark represents a time location within the play time of the digital video. For example, if the play time of a digital video is represented in hours, minutes, and seconds, as 01:20:03, a bookmark time location of 00:20:20 represents a bookmark set 20 minutes and 20 seconds into the play time of the digital video. The DVD player may provide the option for the user to start play of the digital video from the bookmarked location, and if multiple bookmarks are set for digital video, to search through the digital video by forwarded or reversing to the time locations represented by the bookmarks.

While the bookmarking option of a DVD player aids users in individually organizing information, bookmarking is a time consuming process with the end result of one or more bookmarks that are only accessible to the user setting the bookmarks. Thus, the bookmarking option is limited because each user must watch each digital video themselves and set their own bookmarks. DVD players do not facilitate upoloading or downloading of bookmarks. In addition, there is no management tool for collectively sharing bookmarks that one creates or accessing bookmarks that others created.

Therefore, in view of the foregoing, there is a need for a method, system, and program for collective bookmark management at a network accessible location and for media players for facilitating upload and download of bookmarks to collective bookmark management systems.

### SUMMARY OF THE INVENTION

Therefore, the present invention provides a method, system, and program for a collectively bookmark management system to management uploading and downloading of media bookmarks across multiple media systems enabled to control playback of media items.

In one embodiment a bookmark management system uploads user specified bookmarks designating play locations with media items from media systems and stores the bookmarks in a searchable database. The bookmark management system stores bookmarks in the searchable database according to at least one bookmark attribute. Bookmark attributes may include, but are not limited to, the media item marked, a title, a rating, a characteristic of a location marked, a creator identifier, a media system generator identifier.

Media systems may search the searchable database of the bookmark management system according to at least one bookmark attribute and request downloads of the stored bookmarks. The bookmark management system downloads selected bookmarks to requesting media system, wherein the requesting media system enables play of a media item associated with the downloaded bookmarks from the searchable playback locations specified in the bookmarks.

Bookmark management system may be integrated into other types of media systems. In one embodiment, a media distribution system receives a request for a media item, searches for bookmarks associated with the media item, and distributes the requested media item and selected bookmarks to the requesting media system. In another embodiment, a media broadcaster system receives a media selection of a particular broadcast media item, searches for bookmarks created and uploaded by the broadcaster for the media item and any viewer specified bookmarks if available, and downloads the selected bookmarks to the media system such that the media system enables play of the recorded media item associated with the downloaded bookmarks from the searchable playback locations specified in the bookmarks.

In one embodiment, a media system enables a user to create a bookmark designating at least one playable location within a particular media item and at least one characteristic of the marked playable location. The media system uploads the bookmark to at least one bookmark management system to enable other users at other media systems to search for the bookmark by title of the media item and characteristic and to download the bookmark. The media system may apply a level of security required to open the bookmark at another media system. In addition, the media system requests downloads of bookmarks from at least one bookmark management system and enables playback of a media item associated with the bookmarks from the searchable playback locations specified by the downloaded bookmarks.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram of a network environment of at least one system for facilitating collective bookmark management communicatively connected to a plurality of media systems each enabled to control media output;

FIG. 2 is a block diagram illustrating examples of data components of bookmark management preferences;

FIG. 3 is an illustrative example of information included in a bookmark and bookmark set;

FIG. 4 is a block diagram depicting an example of communication between media systems and a bookmark management system to upload and download bookmarks;

FIG. 5 is a block diagram illustrating an example of communications between media systems and a bookmark management system integrated into a media information provider;

FIG. 6 is block diagram depicting an example of communications between media systems and a bookmark management system integrated into a media distributor;

FIG. 7 is a block diagram illustrating an example of communications between media systems and a bookmark management system integrated into a media broadcaster;

FIG. 8 is an illustrative diagram of a media system interface;

FIG. 9 is a block diagram illustrating an example of a computing system which may perform as a media system, a bookmark management system or any of the other systems described herein or implemented collective bookmark management;

FIG. 10 is a high level logic flowchart depicting a process and program for generating bookmarks and uploading bookmarks for media items from a media system to a bookmark management system;

FIG. 11 is a high level logic flowchart illustrating a process and program for a bookmark management system handling communications from media systems;

FIG. 12 is a high level logic flowchart depicting a process and program for a media system managing bookmark downloading;

FIG. 13 is a high level logic flowchart illustrating a process and program for a bookmark management system compiling ratings of bookmarks;

FIG. 14 is a high level logic flowchart depicting a process and program for a media distributor distributing media items and bookmarks; and

FIG. 15 is a high level logic flowchart illustrating a process and program for a media broadcaster broadcasting media items and bookmarks.

### DETAILED DESCRIPTION OF THE PREFERRED EMBODIMENT

The present invention provides a method, system, and program for managing media bookmarks. Media bookmark management systems receive bookmarks uploaded from media systems and download bookmarks to media systems. The media systems are enabled to control media output and in particular, are enabled to control playback of a media item from a time location specified by a bookmark.

The term “media” generally refers to, but is not limited to, audio, video, multi-media presentation, or any other type of data that can be played to produce a sequence of output images or sounds. For example, media may refer to digital music, digital video, or flash-based presentations.

A “media item” generally refers to an audio file, video file, or any other type of data file or files that are playable in a sequence of images or sounds. Each media item may include a play time that specifies the length of the media item in hours, minutes and seconds and a unique code that identifies the media item as a particular “media title”. In addition, each “media title” may include an actual title if each copy of a particular “media title” is assigned a different unique code. The terms “media item” and “media title” may be used interchangeably throughout. Some media items include embedded time marks, which are points specified within the data file for the media item to delineate chapters and scenes, for example. The media item may include a selectable menu from which the user may select to start play of the media item from one of the embedded time marks displayed as a chapter.

The media systems of the present invention detect a user specified bookmark of a media item separately from the embedded time markers within a media item. A “bookmark” of a media item, or media bookmark, is represented most basically by a time code in hours, minutes, and seconds and is a point within the play time of the media item. A media system detecting a bookmark specified for a media item is able to play the media item from the time code specified by the bookmark. In addition, a bookmark may be represented by attributes in addition to a time code including, but not limited to, a bookmark name, the unique code identifying the media title bookmarked, a second time code designating an end time, characteristics of the media at the time code, a creator identity, and other information designated by the user requesting creation of the bookmark or the media system generating the bookmark. In an alternate embodiment, a bookmark may be represented by a particular captured image or sound from a media item, where the media system is enabled to search the media item to locate the point in the media item that matches the bookmark image and play the media item from the located point. Further, it will be understood that a bookmark may be represented by additional or alternate types of information and may be stored in multiple types of file formats.

Multiple bookmarks may be referred to as bookmarks or as a bookmark set. In one example, a bookmark set may include bookmarks grouped for one or more media titles, grouped for one or more characteristics, or grouped based on other criteria. A bookmark set may be represented by a single file compiling the multiple bookmark files or by multiple separate bookmark files referred to by a bookmark set file.

The media systems of the present invention can be implemented within multiple types of computing systems. In one example, a media system is implemented by a computing system such as an electronic telephony device, a portable computing system, a desktop computer, a server system, or other general-purpose computing system where controlling media output is not the primary function of the computing system. In another example, a media system is implemented by a computing system such as a digital video disc (DVD) player, media player, digital video recorder, or other computing device where controlling media output is a primary function of the computing system.

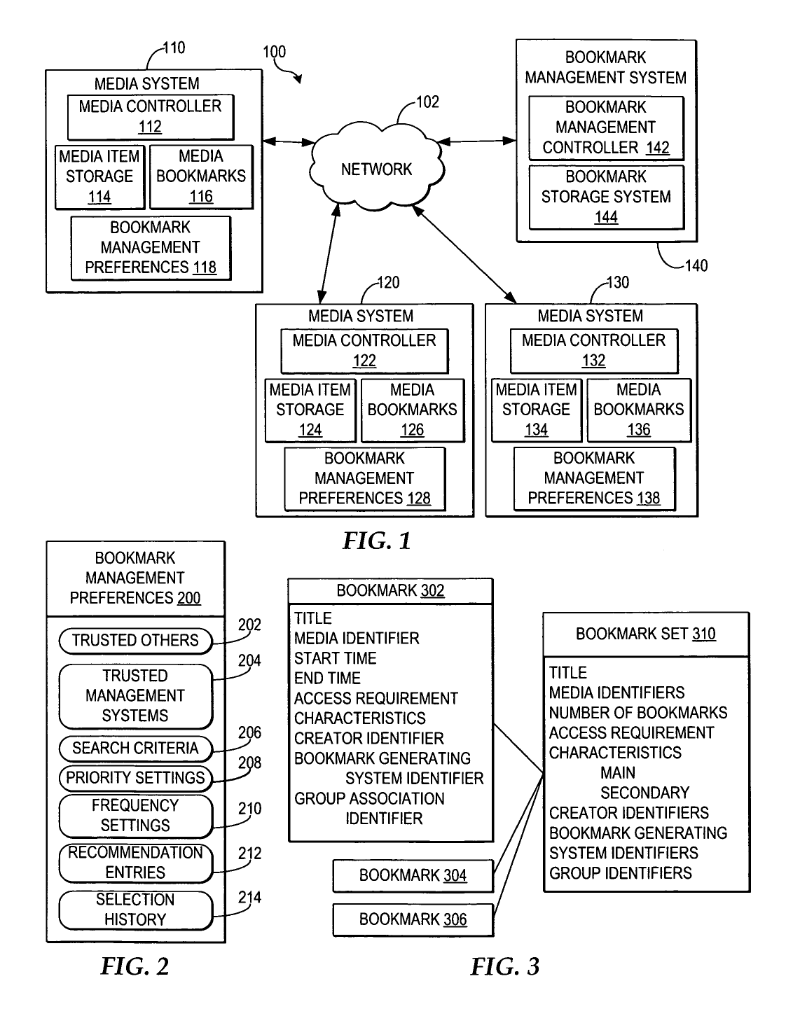

With reference now to FIG. 1, a block diagram depicts a network environment of at least one system for facilitating collective media bookmark management communicatively connected to a plurality of media systems each enabled to control media output. It will be understood that the network environment depicted may be implemented within multiple types of network architectures and that the systems depicted may be implemented using multiple types of computing devices. In addition, it will be understood that network 102, representing the communicative connection between systems, may be include permanent connections such as wire or fiber optics cables and temporary connections made through telephone connections and wireless transmission connections, for example. Network 140 may represent both packet-switching based and telephony based networks, local area and wide area networks, public and private networks. It will be understood that FIG. 1 is representative of one example of network environment for supporting media bookmark management; other types of network facilitated media bookmark management may also be supported.

In the example, multiple media systems 110, 120, and 130, which represent computing devices enabled to control media output, are communicatively connected via a network 102 to at least one bookmark management system that facilitates media bookmark management, such as bookmark management system 140. In particular, bookmark management system 140 facilitates bookmark management through a bookmark management controller 142 for managing upload of bookmarks from media systems 110, 120, and 130 and storage of uploaded bookmarks in a bookmark storage system 144. In addition, bookmark management system 140 facilitates bookmark management through bookmark management controller 142 managing download of bookmarks from bookmark storage system 144 to media systems 110, 120, and 130.

Media systems 110, 120, and 130 are each enabled to control media, including play of media items from bookmarked locations, respectively, through media controllers 112, 122, and 132. For example, media controllers 112, 122, and 132 may provide a selectable option, that when selected by the user, automatically shifts the play location for a media item from the current play location to the time specified by the bookmark following the current play location or preceding the current play location.

In addition, media controllers 112, 122, and 132 provide multiple media playback options for controlling output of media items, including, but not limited to, play, stop, pause, fast forward, or rewind. In addition, media controllers 112, 122, and 132 may provide playback options for controlling output of a media item with embedded time marks. For example, media controllers 112, 122, and 132 may enable a user to select to start play from the next embedded time mark following a current play location or from a next embedded time mark preceding a current play location. It will be understood that media controllers 112, 122, and 132 may provide additional selectable options for enabling a user to select to control output of a media item. In addition, it will be understood that the selectable option for jumping to a next bookmark or embedded time mark may be the same selectable option or different selectable options.

Media controllers 112, 122, and 132 may access media items from media item storage 114, 124, and 134, respectively, from locally or remotely accessible data storage. For example, media item storage 114, 124, and 134 may include, but is not limited to, media items accessible from a DVD or other portable storage medium, media items recorded from broadcast digital media, and media items downloaded via network 102 from a media provider. Media controllers 112, 122, and 132 may provide interfaces for searching through and selecting media items for play.

Media systems 110, 120, and 130 access media bookmarks 116, 126, and 136, respectively, from locally or remotely accessible data storage. Media bookmarks 116, 126, and 136 may include, but are not limited to, media bookmarks set by one or more users at each of the media systems and media bookmarks downloaded from server system 140 or other systems via network 102 from which bookmarks can be downloaded. Media controllers 112, 122, and 132 may provide interfaces for searching through and selecting bookmarks.

In one embodiment, media controllers 112, 122 and 132 enable a user to select specific locations within a media item and set the time code for each specific location as a bookmark. A user may set multiple bookmarks for a single media item. Each bookmark is represented by additional attributes including, but not limited to, the unique code for specifying the media item and a time code for the specific time location, as will be further described with reference to FIG. 3.

In addition, in setting a bookmark, media controllers 112, 122, and 132 may enable a user to set one or more characteristics for the bookmark or group the bookmark within a bookmark set for the media item for the characteristic. For example, for a particular media item, a user may set a first bookmark set of bookmarks with the characteristic of showing a first actor and set a second bookmark set of bookmarks indicating the starting point for each musical song or score of the media item. When a user selects to play the particular media item and the media controller detects that there are two sets of bookmarks, each with a different characteristic, the media controller may provide a selectable option for the user to select which set to use if the user selects to play the media item from a next or previous bookmarked location.

In addition, a bookmark may include both a start time and an end time to be controlled by the media controller. In one example, a user may select a location within a media item and set the time code for the specific location as the end time in the bookmark. In another example, media controllers 112, 122, and 132 may automatically set an end time according to bookmark management preferences 118, 128, and 138, respectively. For example, bookmark management preferences may include preferences directing the media controller to play a media item from each bookmark for a set period of time and then jump to the next bookmark or pause play of the media item.

In another example, a user may select bookmarks for multiple media items and group the bookmarks into a single data file as a bookmark set with a particular characteristic. For example, a user may select to place the bookmarks for a first media item and the bookmarks for a second media item in a bookmark set with a characteristic of “comedy scenes”. When one of media controllers 112, 122, or 132 detects the user selection of a bookmark set with multiple media item bookmarks and the user selects to jump from a first bookmark in the first media item to a second bookmark in the second media item, the media controller automatically opens and plays the second media item from the time code specified for the second bookmark.

Once a user creates a bookmark or a bookmark set through media controllers 116, 126 or 136, the user may select to upload the bookmarks or the media controller may automatically upload the bookmarks. In one example, media controllers 112, 122, and 132 automatically prompt a user to select to upload bookmarks to one or more bookmark management systems specified in bookmark management preferences 118, 128, and 138. In another example, bookmark management systems, such as bookmark management system 140, may prompt a user to select to upload bookmarks to the prompting bookmark management system.

Prior to uploading bookmarks selected by a user, media controllers 116, 126, and 136 may enable a user to select to encrypt bookmarks, to digitally sign bookmarks, to digitally watermark bookmarks, or to apply other methods of securing, signing or authenticating bookmarks. In one example, where a user creates a unique bookmark set, a user may request that the media controller apply a digital watermark to the bookmark set to act as a digital indication of authorship. In addition, bookmark management system 140 may require verification of authorship or encryption of bookmarks.

Bookmark management controller 142 receives uploaded bookmarks and stores the uploaded bookmarks in bookmark storage system 144. In particular, bookmark storage system 144 manages both storage and categorization of bookmarks for searching. Bookmark management controller 142 may interact with the media system uploading the bookmarks and request that the user provide additional information required by bookmark management controller 142 to organize and store bookmarks within bookmark storage system 144. In addition, although not depicted, bookmark management controller 142 may receive bookmarks from other computing systems and data storage systems via network 102.

In addition, bookmark management controller 142 provides an interface for searching the bookmarks within bookmark storage system 144 and selecting to download selected bookmarks within bookmark storage system 144. For example, a user may specify search terms or browse through all the bookmarks for a particular media title that identify comedy scenes within the media title. In another example, bookmark management system 410 may be integrated with another web service, such that the interface provided to a user to search for bookmarks is integrated within the interface for the web service. When media systems 110, 120, and 130 receive downloaded bookmarks, media controllers 112, 122, and 132 store the downloaded bookmarks as media bookmarks 116, 126, and 136.

Further, media controllers 112, 122 and 132 may automatically request searches of and request downloading of bookmarks from bookmark storage system 144 and other systems that facilitate collective media bookmark management based on search preferences specified in bookmark management preferences 118, 128, and 138, respectively. In one example, media controllers 112, 122, and 132 periodically request searching and downloading of bookmarks and in another example for each media new media item detected, media controllers 112, 122, and 132 automatically search and request downloading of bookmarks associated with the new media item. In addition, bookmark management controller 142 may automatically select and download bookmarks to registered media systems or registered users based on downloading preferences specified for the registered media system or registered user logged on at a particular media system.

With reference now to FIG. 2, a block diagram illustrates examples of data components of bookmark management preferences. It will be understood that additional or alternate data components may be implemented in bookmark management preferences 200. In addition, it will be understood that bookmark management preferences 200 may represent the preferences of one or more users or groups.

In the example, bookmark management preferences 200 include trusted others 202. Trusted others 202 includes those other users or systems that are designated as trusted to automatically upload bookmarks to or download bookmarks from. In one example, media controller 112 may access trusted others 202 to filter uploads and downloads of bookmarks. In addition, media controller 112 may pass the list of trusted others 202 to bookmark management controller 142, where bookmark management controller 142 then filters search criteria for bookmarks in bookmark storage system 144 according to trusted others 202. Further, media controller 112 and other systems may use trusted others 202 for other types of search filtering and uploading and downloading options. In particular, if a downloaded bookmark does not include an identifier included in trusted others 202, then media controller 112 may prompt the user to accept or reject the bookmark.

A “trusted other” may include an individual identifier for the creator of the bookmark, an identifier for the media system generating the bookmark, or a group identifier for a group that a creating user belongs to. In addition, a “trusted other” may include a network identifier for computing systems that implement a bookmark management system. Further, a “trusted other” may include a minimum compiled rating requirement. In addition, it will be understood that additional or alternate criteria may identify those users or systems that are trusted to upload bookmarks from or download bookmarks to.

A user may specify the entries in trusted others 202 in multiple ways. For example, a user may download a bookmark set created by an individual identified as “user I” and a member of a group identified as “A+ bookmarkers” and play through a media item using the bookmark set. Bookmark management controller 142 then prompts the user to select whether or not to specify either or both of the individual identified as “user 1” and the group identifier of“A+ bookmarkers” in trusted others 202. In another example, bookmark management controller 142 may prompt a user to specify the minimum rating level for a trusted communication, when a rating level is available, such as where bookmark management controller 142 manages receiving ratings and compiling ratings of downloaded bookmarks. It will be understood that additional and alternate interfaces may be provided for a user to specify identifiers for storage in trusted others 202 through multiple types of selection interfaces.

In addition, to a user specifying entries in trusted others 202, each of media controllers 112, 122, and 132 include a corpus controller for monitoring the bookmarking selections of a user, storing a user's selections over time in selection history 214, detecting patterns from selection history 214, and automatically adjusting the user preferences based on monitored patterns. For example, media controller 112 may detect a user rate the bookmarks five downloaded bookmarks created by a particular user with a rating less than 5 on a scale of 1 to 10 and automatically adjust trusted users 202 to remove the identifier for the creating user. In another example, media controller 112 may detect a user consistently accept downloaded bookmarks created by individuals who are members of a particular group and automatically add the group identifier to trusted users 202.

In addition, bookmark management preferences 200 includes trusted management systems 204. Trusted management systems 204 include a trusted list of bookmark management systems accessible by the media controller via network 102. For example, bookmark management system 140 may be listed in trusted management systems 204. Media controller 112 may automatically access one of the services listed in trusted management systems 204 to upload user bookmarks or to request and download bookmarks.

In one example, a media player is shipped with selected bookmark management systems specified in trusted management systems 204. The media controller may enable a user to add or adjust the specified bookmark management systems in trusted management systems 204 or the corpus controller may monitor user interaction with bookmark management systems, based on the stored interactions in selection history 214, and automatically adjust the systems listed in trusted management systems 204 based on the monitored patterns. In addition, the media controller may receive updates to the list of bookmark management systems originally specified in trusted management systems 204 from an update server or service. Alternatively, a media player may be limited to uploading bookmarks to and downloading bookmarks from a particular service specified in trusted management systems 204.

Each service specified in trusted management systems 204 is also characterized by ratings and categories, for example. A user may select the rating for a bookmark management system, such as a rating on a numerical scale from 1 to 10. In addition, a user may select categories for a bookmark management system, such as whether that system is to be associated with one or more genres of media such as comedy and drama. Further, if a user selects to add a particular system to trusted management systems 204, the selected bookmark management system may specify categories of service. For example, a particular bookmark management system that only focuses on bookmarks for restored films now available in a digital media format may provide a profile that is then stored with the identifier for the service in trusted management systems 204.

Bookmark management preferences 200 also include search criteria 206. Search criteria 206 specify the criteria for the media controller or a bookmark management controller to use in searching for, filtering, and selecting bookmarks to download to a media system. In one example, a user may specify to search for bookmarks with the actor specified as “Jim Carrey”, the category “comedy”, and ratings of greater than 7 on a scale of 1 to 10. In another example, a user may specify to search for bookmarks for a particular media title with a rating greater than 9 on a scale of 1 to 10. It will be understood that additional and alternate search criteria terms may be specified for searching for bookmarks. In addition, it will be understood that search criteria 206 are further limited by the listings in trusted others 202 and trusted management systems 206.

A user may specify the terms of search criteria 206 through an interface provided by the media controller. In another example, the media controller may capture any search terms entered by a user at an interface provided by bookmark management controller 142 for searching bookmark storage system 144 and add the captured terms to search criteria 206. Further, the corpus controller may monitor search patterns, from previous searches stored in selection history 214, and automatically adjust the search terms set in search criteria 206 according to the monitored search patterns.

Bookmark management preferences 200 also include priority settings 208. Priority settings 208 specify how to prioritize bookmarks and bookmark search results. For example, if a user specifies in priority settings 208 to prioritize all bookmarks by genre first, then the media controller will control display of bookmarks first according to genre. If the user specifies in priority settings 208 to prioritize all bookmarks within the genre by rating, from highest to lowest, then the media controller will control display of bookmarks by genre and then within each genre, by rating from highest to lowest. In addition, the corpus controller may detect user patterns in selecting bookmarks, from the previous priority selections stored in selection history 214, calculate user priorities, and automatically adjust priority settings 208 to include the calculated priorities.

In addition, bookmark management preferences 200 includes frequency settings 210. Frequency settings 210 indicate whether the media controller should automatically search for and download bookmarks according to search criteria from the services specified in trusted management systems 204 and limited to those identifiers specified in other trusted others 202. If the frequency settings are set to automatically search for and download bookmarks, then a setting is specified for how often the media controller should be triggered to perform the search. In addition, the corpus controller may monitor user bookmark uploading, searching, and downloading frequencies from selection history 214, calculate average frequencies for each, and adjust frequency settings 210 to reflect the calculated averages.

In addition, the corpus controller may monitor and periodically perform statistical analysis of a user's bookmarking behavior and the characteristics of the bookmarks downloaded by the user, based on user selections stored in selection history 214, to generate recommendations for that user for future media and bookmark download selections. The media controller presents recommendations to the user and stores the recommendations in recommendation entries 212. In addition, recommendations received from bookmark management services are stored in recommendation entries 212. The media controller may present the recommendations to the user in multiple formats. For example, the media controller may list recommendations sorted according to priority settings 208. In another example, the media controller may add a graphical identification to recommended bookmarks whenever a selectable option for a recommended bookmark is displayed.

In one example of a generated recommendation, the media controller detects that the bookmark that the user rates highly for media item “A” is created by a user who also created bookmarks for media item “B” which is stored on the media player and therefore media controller recommends the bookmark for media item “B” to the user. In another example of a generated recommendation, the media controller detects that the user rates bookmarks that identify the start of musical scores with a high rating, the media controller searches bookmark management systems for bookmarks for other media titles that mark the start of each musical score, the media controller downloads the located bookmarks and presents the located bookmarks to the user as “bookmarks you might like because you like these other bookmarks identifying the start locations of musical scores.”

Referring now to FIG. 3, there is depicted one example of information included in a bookmark and bookmark set. In the example, multiple bookmarks 302, 304, and 306 are depicted. It will be understood that additional or alternate numbers and types of bookmarks may be selected. The types of attributes defining each bookmark are illustrated with reference to bookmark 302. For example, bookmark attributes may include a title, a media identifier to uniquely identify the media item bookmarked, a start time code, an end time code, an access requirement for restricting access to the bookmark, any characteristics of the bookmark, a creator identifier, a bookmark generator identifier, and a group association identifier.

Multiple bookmarks may be grouped together as individual data files or a single data file represented by bookmark set 310. In the example, the attributes defining a bookmark set are depicted. For example, a bookmark set may include the name of the bookmark set, the media identifiers included in the bookmarks of the bookmark set, the number of bookmarks, an overall access restriction, the main and secondary characteristics of the bookmark set, and the creator identifiers, generator identifiers, and group identifiers for the bookmarks. It will be understood that any number or type of characteristics of the bookmark set may be specified. In addition, it is important to note that bookmarks created by different users may be added to bookmark set 310.

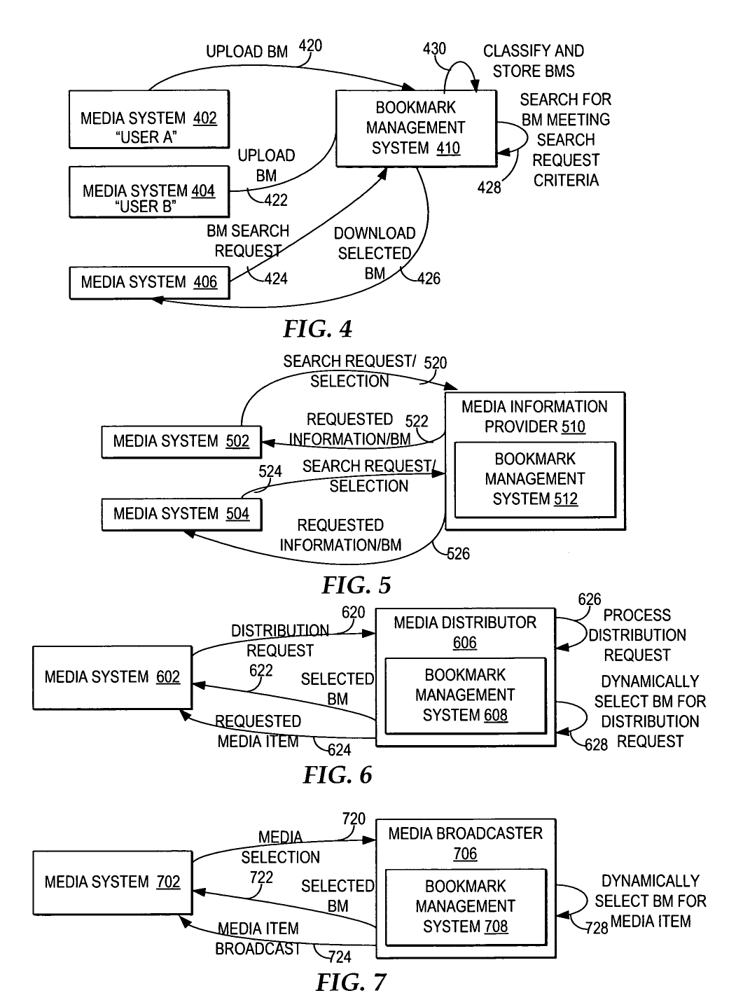

With reference now to FIG. 4, a block diagram illustrates an example of communication between media systems and a bookmark management system to upload and download bookmarks. In the embodiment, media systems 402, 404, and 406 are communicatively connected to a bookmark management system 410. “User A” at media system 402 and “user B” at media system 404 have each created bookmarks (BM) for a particular media item with a particular characteristic. The bookmarks are uploaded to bookmark management system 410, as illustrated at reference numerals 420 and 422. Bookmark management system 410 classifies and stores the uploaded bookmarks in bookmark storage system 412, as illustrated at reference numeral 430, with other bookmarks previous uploaded from media systems, including, but not limited to, media systems 402, 404, and 406. As illustrated at reference numeral 424, media system 406 sends a search request for downloading bookmarks for the particular media item with the particular characteristic and, as illustrated at reference numeral 424, bookmark management system 410 searches for bookmarks meeting the search request criteria as illustrated at reference numeral 428 and, in the example, downloads the bookmarks uploaded from “user A” and “user B” to media system 406, as illustrated at reference numeral 426.

Bookmarks uploaded from media systems may be uploaded and stored individually, but when bookmark management system 410 selects a selection of the bookmarks meeting a search request, bookmark management system 410 generates a bookmark set of the bookmarks for download to the requesting media system. In addition, bookmarks uploaded from media systems may be uploaded and stored in bookmark sets. Bookmark management system 410 may generate a new bookmark set, in response to a search request, by merging multiple uploaded bookmark sets or merging individual uploaded bookmarks into an uploaded bookmark set.

In one example, “user A” and “user B” each select bookmarks for a media item titled “IBM Training Video” and upload the bookmarks to bookmark management system 410, as illustrated at reference numerals 420 and 422. The bookmarks created by “user A” are specified as marking references to “installing upgrades” and the bookmark set created by “user B” is set as marking references to “contacting a manager.” “User A” further specifies the bookmarks as restricted to access only by users a particular level of security clearance. “User C” logged in at media system 406 requests to watch the media item titled “IBM Training Video”. Upon opening the video file, media system 406 automatically generates a request to download all bookmark sets from bookmark management system 410 that are specified for the media title, as illustrated at reference numeral 424. Bookmark management system 410 searches for bookmarks stored for the media item and identifies the bookmarks uploaded by “user A” and “user B” as bookmarks specified for the media title. Bookmark management system 410 then detects that “User C” does not have the required level of security clearance required to access the bookmark uploaded by “user A”, so bookmark management system 410 only downloads the bookmark set uploaded by “User B” for the media title as illustrated at reference numeral 426. In another example, “user A” may restrict access by encrypting the bookmarks such that only users with a particular key may decrypt the bookmarks, where the key is only accessible to a selection of users with a particular level of security clearance.

In another example, “user A” and “user B” each select bookmarks for different media items and upload the bookmarks to bookmark management system 410, as illustrated at reference numerals 420 and 422. Bookmark management system 410 stores the bookmarks according to media title and characteristics. For example, “user A” selects bookmarks for a digitally recorded program titled “show A” and “user B” selects bookmarks for a digital video titled “movie B”. Both users specify that the bookmarks indicate locations where “actress C” enters the scene. Media system 406 sends a search request, as illustrated at reference numeral 424, for bookmarks for media items, where the bookmarks indicate locations where “actress C” enters the scene. Bookmark management system 410 identifies the bookmarks uploaded by “user A” and “user B” as meeting the search criteria and downloads the selected bookmarks to media system 406, as illustrated at reference numeral 426.

In yet another example, “user A” selects bookmarks for a media item while watching and then sorts the bookmarks into separate bookmark sets where a first bookmark set characteristic is the name of the actress appearing in the scenes marked and a second bookmark set characteristic is that the bookmarks indicate that a new song starts at each scene marked. Media player 402 uploads each of the bookmark sets to bookmark management system 410 and bookmark management system 410 separately classifies and stores each bookmark set.

In a further example, “user C” watches a media item with the downloaded bookmarks created by “user A” and “user B”, searches through the media item using the bookmarks, and selects particular bookmarks within the bookmark set to add to a new bookmark set. The new bookmark set generated by media system 406 may upload the new bookmark set to bookmark management system 410, indicating that the new bookmark set includes bookmarks from the previously downloaded bookmark sets.

Referring now to FIG. 5, a block diagram illustrates an example of communications between media systems and a bookmark management system integrated into a media information provider.

In the embodiment, media systems 502 and 504 are communicatively connected to a media information provider 510. Media information provider 510 includes a bookmark management system 512 which may be locally or remotely accessible to media information provider 510. Bookmark management system 510, as previously described, manages uploading of bookmarks from client systems, storage of bookmarks and downloading of bookmarks to media systems, as described with reference to FIG. 1. In addition, media information provider 510 may select and add bookmarks to bookmark management system 512. For example, a media reviewer who provides media reviews to media information provider 510 for distribution to users may also create a bookmark sets for distribution in conjunction with the movie reviews.

Media information provider 510 manages gathering, compilation, and distribution of information about media. In particular, media information provider 510 provides users with access to information about media items including, but not limited to, the media personnel, release date, original release medium, reviews, ratings, current show locations, digital distribution release date, and other information describing the contents of a media item, relevant dates associated with a media item, response to the media item and distribution of the media item. Media information provider 510 may manage information about a single media item or multiple media items. In particular, although not depicted, media information provider 510 may include a media information gathering controller for gathering information about media from other systems, a ratings gathering controller for prompting users to provide ratings and reviews about media items, and other controllers for gathering, storing, and distributing media information. In addition, a user may subscribe to the information service provided by media information provider 510.

In one example, media information provider 510 provides an interface through a web page that includes options for a user to scan the information, including an options for a user or media system to enter search criteria. In another example, media information provider 510 provides an interface through a web page tailored for display on a portable communication device, such as a telephony device enabled with data network access.

Further, in yet another example, media information provider 510 interfaces with media systems 502 and 504 through a chat session facilitated by media information provider 510 or another system that supports chat communications. In the example, media information provider 510 communicates with the user through a bot that represents a participant in a chat session. A user at one of media systems 502 or 504 may request a chat session with the bot in the same manner that the user would request a chat session with another user. The bot sends messages in the chat session that direct the user what characters to input to direct the bot to search, the bot reads the messages sent by the user, the bot searches the media information accessible to media information provider 510 according to the search terms, and the bot returns searched results from media information provider 510 in messages in the chat session. It will be understood that a chat session may include, but is not limited to, instant messaging sessions, Internet Relay Chat (IRC) sessions, and other sessions supported by a packet-switching channel opened to support chat communication.

Since media information provider 510 includes a bookmark management system 512, media information provider 510 may also provide information about available bookmarks that match the search criteria entered by a user for a media item. As illustrated in the figure, media information provider 510 concurrently handles requests from multiple media systems, such as media systems 502 and 504. Media systems 502 and 504 each send search requests or selections from the interface provided by media information provider 510 showing available information and bookmark selections, as illustrated at reference numerals 520 and 524. Media information provider 510 processes the requests and returns the requested information including information about available bookmarks for download, as illustrated at reference numerals 522 and 526.

In an example, if a user enters a search requesting a listing of all media items in which “actress C” performed, media information provider 510 may search for the media information for all media titles in which “actress C” performed and search the bookmark management system for all bookmarks with a characteristics of identified locations at which “actress C” enters the scene. Media information provider 510 returns the accessed list of movie titles and selectable bookmarks identifying scenes with “actress C”. A user receiving the returned search results may select a media title to view more information about that movie title or may select to download one or more bookmarks associated with the media title. Even within a chat session, the bot may direct the user how to select to search for and download bookmarks and the bot may sends a message downloading selected bookmarks to the requesting media system through the chat session.

In addition, continuing with the example of a search for “actress C”, if a user at media system 502 selects to download one or more of the bookmarks returned in the search results, media information provider 510 may detect whether media system 502 has access to the media titles associated with the selected bookmarks. For those media items not included in media item storage of media system 502, media information provider 510 may facilitate connecting media system 502 with a media provider that can provide the user access to the media titles associated with the selected bookmarks.

Further, media information provider 510 may require user registration, which requires a user to provide information about user preferences. Media information provider 510 may also monitor choices by the registered user, detect patterns in user searching and selection over time, and adjust user preferences and recommend media items and bookmarks according to the adjusted user preferences.

In addition, media information provider 510 may include a service that periodically searches for new information associated with a user profile and delivers the identified information, including downloadable bookmarks. For example, if a user profile indicates that a user prefers movies rated as suitable for children and requests weekly updates of new media information meeting the profile specifications, media information provider 510 performs a weekly search of the available media information and bookmarks and automatically sends the search result to the requesting user. In addition, media information provider 510 may dynamically select information based on a user profile and personalize the interface provided to a user to access the media information provider service with the dynamically selected information.

In another example, media information provider 510 may provide a subscription to users to each create an individual, customizable web page with an option to add an interface for uploading and downloading selectable bookmarks. For example, a web blog or other personal web page service may provide subscribers with the option to upload bookmarks to the personal web page so that other users may then download the personal web page. In the example bookmark management system 512 manages the actual storage and classifying of the bookmarks, but media information provider 510 returns the links to the individual pages that include bookmarks meeting the search criteria in search requests received from media systems.

With reference now to FIG. 6, a block diagram illustrates an example of communications between media systems and a bookmark management system integrated into a media distributor. In the example, media system 602 is communicatively connected to a media distributor 606. Media distributor 606 includes a bookmark management system 608 which may be locally or remotely accessible to media distributor 606. Bookmark management system 608 manages uploading of bookmarks from client systems, storage of bookmarks and downloading of bookmarks to media systems, as described with reference to FIG. 1. In addition, media distributor 606 may specify bookmarks for those media items offered by media distributor 606.

Media distributor 606 provides a service for distributing media items to users. In one example, media distributor 606 distributes media items by downloading copies of media items to media system 602, as illustrated at reference numeral 624. In another example, media distributor 606 distributes media items by providing an interface through which a user at media system 602 may select to receive a shipped copy of the selected media item on a portable data storage medium, such as a DVD. It will be understood that media provider 606 may provide media system 602 with a playable copy of a media item through additional or alternate data transfer mediums. In addition, it will be understood that media provider 606 may require a user to provide a payment or other consideration in exchange for media provider 606 providing the media item.

Advantageously, when a user selects to access a media item, such as through the distribution request illustrated at reference numeral 620, bookmark management system 608 processes the distribution request, as illustrated at reference numeral 626, and also dynamically selects bookmarks associated with the media item to download to the requesting user at media system 602, as illustrated at reference numeral 628. Thus, as illustrated at reference numerals 622 and 624, media distributor 606 downloads both the dynamically selected bookmarks and the requested media item to media system 602.

For bookmark management system 608 to dynamically selecting bookmarks for the distribution request, bookmark management system 608 may track preferences for the user or may request that the user provide preferences for bookmarks. Bookmark management system 608 dynamically selects bookmarks to download to the requesting user for the media item based on the user preferences and other factors set by media distributor 606. In one example, if a user indicates a preference for prioritizing comedy scenes first and dramatic scenes second, then bookmark management system 608 dynamically selects bookmarks for a particular media item, where a first bookmark set marks the comedy scenes in the media item and the second bookmark set marks the dramatic scenes in the media item.

In one example, if media provider 606 downloads selected media items to media system 602, the user may be prompted to select from among bookmarks to be downloaded with the media items or the dynamically selected bookmarks may be automatically downloaded with the media items. In another example, if media provider 606 ships selected media items on a portable data storage medium, such as a DVD, media provider 606 may download the bookmarks to media system 602 or send the bookmarks through other communications, such as attached to an email or represented within a selectable link within an email sent to the user to indicate that the media item has shipped.

Media distributor 606 may also provide media information, such that subscribers to media distributor 606 may search through and download bookmarks without also requesting a distribution of a media item. In addition, media distributor 606 may also provide an incentive system for users who receive media items and bookmarks to rate the media items and bookmarks.

Referring now to FIG. 7, a block diagram illustrates an example of communications between media systems and a bookmark management system integrated into a media broadcaster. In the example, a media system 702 is communicatively connected to a media broadcaster 706. Media broadcaster 706 includes a bookmark management system 708 which may be locally or remotely accessible to media broadcaster 706. Bookmark management system 708 manages uploading of bookmarks from client systems, storage of bookmarks and downloading of bookmarks to media systems, as described with reference to FIG. 1. In addition, media broadcaster 706 may specify bookmarks for those media items offered by media broadcaster 706.

Media broadcaster 706 controls the broadcast of media items, where broadcasting includes, but is not limited to, digital television broadcasting and video streaming. Media broadcaster 706 may broadcast media items for reception by media system 702, as illustrated at reference numeral 724, where media system 702 is enabled to receive the broadcast signal from media broadcaster 706. In one example, media system 702 is a digital video recorder enabled to receive, record, and control output of a digital television broadcast. In another example, media system 702 is a telephony device enabled to receive and control output of streaming video or broadcast digital video.

In addition, media broadcaster 706 downloads bookmarks for broadcast media items, as illustrated at reference numeral 722. In one example, bookmarks for broadcast media items are downloaded prior to the broadcasting or in conjunction with the broadcasting. In one example, media system 702 may transmit an indicator of a media selection, as illustrated at reference numeral 720, where the media selection indicates a selection of a media item for download, a selection to record a media item, or a selection to play a recorded media item, for example.

As illustrated at reference numeral 728, bookmark management system 708 dynamically selects bookmarks for the media item selection. In dynamically selecting bookmarks for the media item, media broadcaster 706 may select bookmark sets characterized by the actors entering the scene, the music started, and other selectable characteristics of the television program, the locations of which are specified in the bookmark sets. In addition, in dynamically selecting bookmarks for the media item, media broadcaster 706 may access user bookmarking preferences stored by bookmark management system 708, passed with media selection 720, or by querying media system 702, and select bookmarks for the media item that match the user bookmarking preferences.

In one example, media broadcaster 706 receives media selection 720 indicating that media system 702 is set to record a particular television program to broadcast, bookmark management system 708 dynamically selects bookmarks for the television program for media system 702, as illustrated at reference numeral 728, and downloads the selected bookmarks to media system 702, as illustrated at reference numeral 722.

In another example, media broadcaster 706 receives media selection 720 indicating that media system 702 is going to play a recording of the broadcast media item. Bookmark management system 708 dynamically selects bookmarks for the recorded program for media system 702, as illustrated at reference numeral 728, and downloads the selected bookmarks to media system 702, as illustrated at reference numeral 722. In an alternate example, media selection 720 may indicate that media system 702 has stored the recording for a preselected period of time to allow other users to upload bookmarks and media system 702 is requesting

In addition, media system 702 may enable users to create new bookmarks for a media item as the media item is played either from the live broadcast or a recording of the media item. Media system 702 uploads the bookmarks to media broadcaster 706, which then enables other media systems to download the bookmarks. Media system 702 may automatically trigger a request for bookmarks from media broadcaster 706 at some time period after the recording of a media item, where the time period is sufficient to allow time for other users to upload bookmarks for the media item after the live broadcast.

It is important to note that media system 702 may access other systems that provide bookmark management of bookmarks for the downloaded media item and download bookmarks for the media item from the other bookmark management systems. For example, media system 702 may access a bookmark management system that provides downloads of bookmarks for broadcast media items marking the start of scenes following commercials in the original broadcast time.

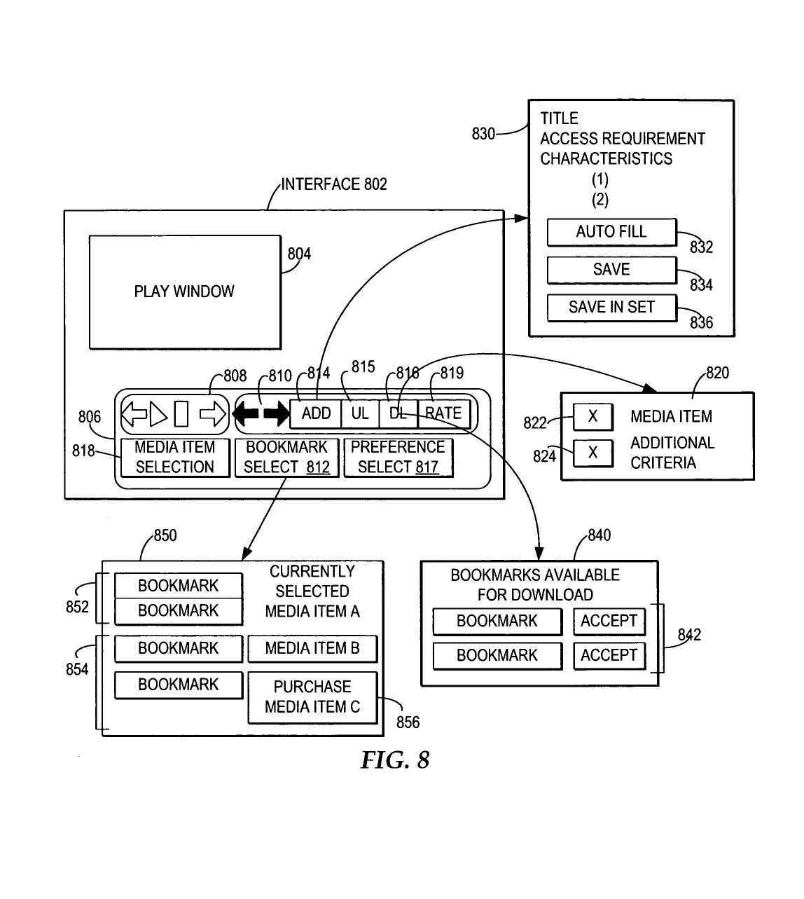

With reference now to FIG. 8, an illustrative diagram depicts a media system interface. In the example, interface 802 includes a window 804 for displaying play of a media item. A media player 806 includes selectable options for controlling play of a media item. It will be understood that while the selectable options of media player 806 are described with reference to selectable graphical objects, other input and selection options may be provided and different types of selectable graphical objects may be implemented. Further, it will be understood that media player 806 may include additional or alternate selectable options from those described in the example.

In the example, a control panel of media player 806 includes selectable options for backward, play, pause, and forward, as illustrated at reference numeral 808. In addition, the control panel of media player 806 includes selectable options for backward to previous bookmark or forward to next bookmark, as illustrated at reference numeral 810.

Media player 806 includes a media selection option 818 represented by a selectable button that triggers a pull down menu of selectable media titles, where the media title currently playing is displayed unless the user selects the selectable button. In addition, a bookmark selection option 812 is represented by a selectable button that triggers a pull down menu of selectable bookmarks, where the bookmark currently selected is displayed unless the user selects the selectable button. In one example, illustrated in pull down interface 850, media player 806 first lists the bookmarks associated with the currently listed media title, as illustrated at reference numeral 852 and then lists in a prioritized order other downloaded bookmarks, as illustrated at reference numeral 854. If a user selects one of the other bookmarks for a different media item, media player 806 may automatically load the new media item and adjust the media item listing in option 818. If media player 806 lists downloaded bookmarks for media items that are not currently available to media player 806, media player 806 may include a selectable media access option 856 with the bookmark. If a user selects to access the media item, then media player 806 locates a media broadcaster system or media distributor system that provides access to the media item and initiates the acquisition process with that media broadcaster system or media distributor system.

Further, media player 806 includes an add bookmark option (ADD) 814. When a user selects add bookmark option 814, the user is prompted with an additional interface, such as bookmark information interface 830, which prompts the user to provide additional information about the bookmark. If the user selects add bookmark option 814 while a media item is playing, then the media system automatically adds the media item unique identifier and title and the time location at which the user selected the add option. In addition, as illustrated in interface 830, a user may select a title for the bookmark, characteristics of the bookmark, access restrictions for the bookmark, and other information. In one example, a user may select a default option 832 that automatically fills in the information based on user bookmarking preferences. A user selects save option 834 to save the bookmark individually or selects save in set option 836 to save the bookmark in a particular bookmark set. It will be understood that bookmark information interface 830 may include additional or alternate types of information and selectable options for entering and saving bookmark information.

In addition, media player 806 includes an upload bookmark option (UL) 815. A user may select to upload the bookmark that is currently selected as indicated at bookmark selection option 812. In addition, a user may select to other bookmarks, such as all recently created bookmarks. The bookmark management systems to which a user selects to upload bookmarks may prompt the user to provide additional information about bookmarks that is required by an individual bookmark management system for storing uploaded bookmarks.

Media player 806 includes a download bookmark option 816. Upon user selection of download bookmark option 816, the user is prompted with an additional interface, such as download selection interface 820. Download selection interface 820 includes a search request form for selection by the user. In one example, the media system automatically generates the terms of a search request based on user bookmarking preferences. For example, a user may select auto-search option 822 to send the search terms generated by the media system. In another example, a user may select to add to, change, or delete the terms selected by the media system using option 824. In the example, the user may adjust, for example, any of the trusted others, bookmark management systems, search criteria, and priorities automatically placed in a search request. The media system, for example, may automatically specify the media title to be searched as the media title currently displayed in media selection 818 or may automatically specify the bookmark characteristics to be searched as the characteristics of the bookmark currently displayed in option 812. By selecting option 824, the user may add additional media titles, change the media title, or select no media title and the user may add additional characteristics, change the characteristics, or select no characteristics.

In addition, media player 806 includes a user bookmark preference selection option 817. Upon selection of option 817, a user may adjust the information described with respect to FIG. 2 and other preference information. In addition, upon selection of option 817, the media system may provide the user with an additional interface showing the current preferences where preferences selected by the user are graphically distinguished from preferences inserted by the media system corpus controller.

As the media system detects newly downloaded bookmarks, the media system may prompt the user to accept or reject each bookmark download. For example, an additional interface, such as interface 840 may prompt the user with the title for each bookmark and a selectable option to accept or reject the bookmark, as illustrated at reference numeral 842.

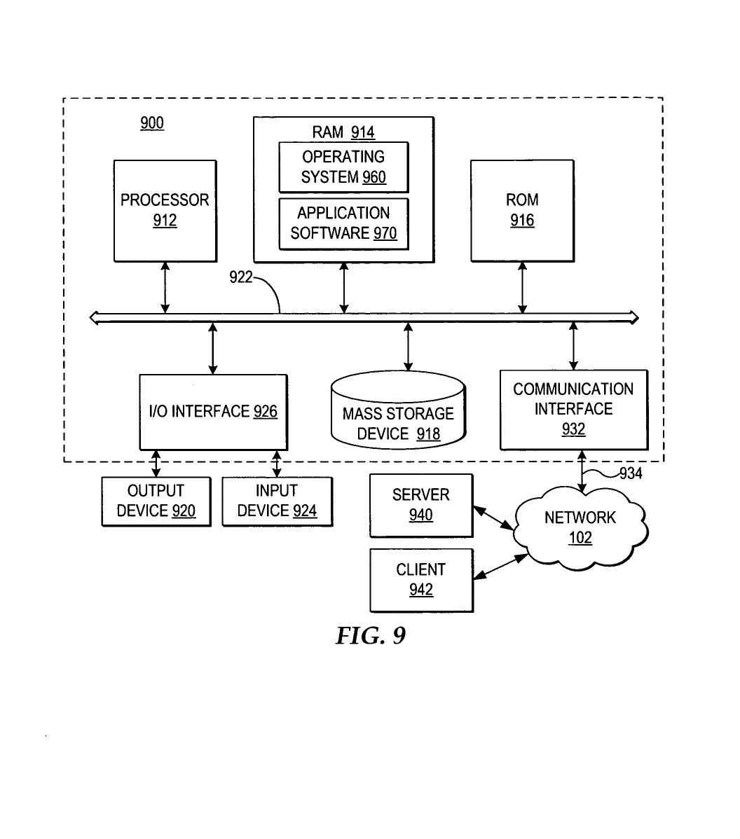

With reference now to FIG. 9, a block diagram illustrates an example of a computing system which may perform as a media system, a bookmark management system or any of the other systems described herein or implemented collective bookmark management. The present invention may be executed in a variety of systems, including a variety of computing systems and electronic devices.

Computer system 900 includes a bus 922 or other communication device for communicating information within computer system 900, and at least one processing device such as processor 912, coupled to bus 922 for processing information. Bus 922 preferably includes low-latency and higher latency paths that are connected by bridges and adapters and controlled within computer system 900 by multiple bus controllers. In one example, when implemented as a server system, computer system 900 may include multiple processors designed to improve network servicing power.

Processor 912 may be a general-purpose processor such as IBM's PowerPC™ processor that, during normal operation, processes data under the control of an operating system 960, application software 970, middleware (not depicted), and other code accessible from a dynamic storage device such as random access memory (RAM) 914, a static storage device such as Read Only Memory (ROM) 916, a data storage device, such as mass storage device 918, or other data storage medium. Operating system 960 may provide a graphical user interface (GUI) to the user. In one embodiment, application software 970 may contain machine executable instructions for managing a media player, a bookmark management system or other system described herein, that when executed on processor 912 carry out the operations depicted in the flowcharts and other operations described herein. Alternatively, the steps of the present invention might be performed by specific hardware components that contain hardwired logic for performing the steps, or by any combination of programmed computer components and custom hardware components.

The systems and controllers of the present invention may be provided as a computer program product, included on a machine-readable medium having stored thereon the machine executable instructions used to program computer system 900 to perform a process according to the present invention. The term “machine-readable medium” as used herein includes any medium that participates in providing instructions to processor 912 or other components of computer system 900 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 900 can read and which is suitable for storing instructions. In the present embodiment, an example of a non-volatile medium is mass storage device 918 which as depicted is an internal component of computer system 900, but will be understood to also be provided by an external device. Volatile media include dynamic memory such as RAM 914. Transmission media include coaxial cables, copper wire or fiber optics, including the wires that comprise bus 922. Transmission media can also take the form of acoustic or light waves, such as those generated during radio frequency or infrared data communications.

Moreover, the present invention may be downloaded as a computer program product, wherein the program instructions may be transferred from a remote computer such as a server 940 to requesting computer system 900 by way of data signals embodied in a carrier wave or other propagation medium via a network link 934 (e.g. a modem or network connection) to a communications interface 932 coupled to bus 922. Communications interface 932 provides a two-way data communications coupling to network link 934 that may be connected, for example, to a local area network (LAN), wide area network (WAN), or directly to an Internet Service Provider (ISP). In particular, network link 934 may provide wired and/or wireless network communications to one or more networks, such as network 102.

Network link 934 and network 102 both use electrical, electromagnetic, or optical signals that carry digital data streams. The signals through the various networks and the signals on network link 934 and through communication interface 932, which carry the digital data to and from computer system 900, are forms of carrier waves transporting the information.

When implemented as a network server, computer system 900 may include multiple communication interfaces accessible via multiple peripheral component interconnect (PCI) bus bridges connected to an input/output controller. In this manner, computer system 900 allows connections to multiple network computers, such as client 942, via multiple separate ports.

In addition, computer system 900 typically includes multiple peripheral components that facilitate communication. These peripheral components are connected to multiple controllers, adapters, and expansion slots, such as input/output (I/O) interface 926, coupled to one of the multiple levels of bus 922. For example, input device 924 may include, for example, a microphone, a keyboard, a mouse, or other input peripheral device, communicatively enabled on bus 922 via I/O interface 926 controlling inputs. In addition, for example, a output device 920 communicatively enabled on bus 922 via I/O interface 926 for controlling outputs may include, for example, one or more graphical display devices, but may also include other output interfaces, such as an audio output interface. In alternate embodiments of the present invention, additional input and output peripheral components may be added.

Those of ordinary skill in the art will appreciate that the hardware depicted in FIG. 9 may vary. Furthermore, those of ordinary skill in the art will appreciate that the depicted example is not meant to imply architectural limitations with respect to the present invention.

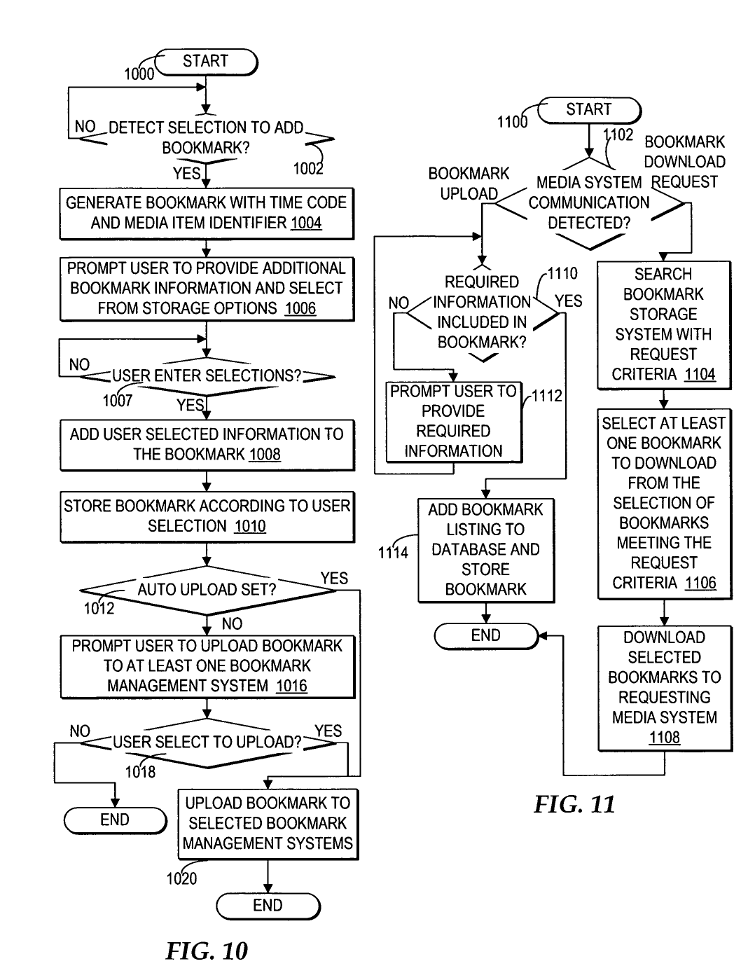

Referring now to FIG. 10, a high level logic flowchart depicts a process and program for generating bookmarks and uploading bookmarks for media items from a media system to a bookmark management system. In the example, the process performed by the media system starts at block 1000 and thereafter proceeds to block 1002. Block 1002 depicts a determination by the media system whether the user selects to add a bookmark for a media item. If a user selects to add a bookmark for a media item, then the process passes to block 1004. Block 1004 illustrates generating a bookmark with the time code indicating the location within the media item when the user triggered the bookmark and the unique identifier for the media title. Next, block 1006 depicts prompting the user to provide additional information for describing the bookmark and to select from storage options. Storage options may include, for example, store and upload, store locally, and store in a bookmark set. Block 1007 depicts a determination whether the user enters selections and provides information. Once the user provides information, the process passes to block 1008. Block 1008 illustrates adding the user specified information to the bookmark and block 1010 depicts storing the bookmark according to the user selected option.

Next, block 1012 illustrates a determination whether a preference to automatically upload the bookmark is set. If a preference is set, then the process passes to block 1020. Block 1020 depicts uploading the bookmark to the selected bookmark management systems, and the process ends. Otherwise, at block 1012, if preference is not set to automatically upload, then the process passes to block 1016. Block 1016 depicts prompting the user to select to upload the bookmark to at least one bookmark management system. Next, block 1018 depicts a determination where the user selects to upload the bookmark. If the user does not select to upload the bookmark, then the process ends. If the user selects to upload the bookmark, then the process passes to block 1020.

With reference now to FIG. 11, a high level logic flowchart depicts a program and process for a bookmark management system handling communications from media systems. As illustrated, the process starts at block 1100 and thereafter proceeds to block 1102. Block 1102 depicts a determination of the type of communication detected. If the communication detected is a bookmark upload, then the process passes to block 1110. Block 1110 depicts a determination by the bookmark management system whether the bookmark upload includes all the information required by the bookmark management system for cataloging and storing the bookmark. If the bookmark upload does not include all the required information, then the process passes to block 1112 and the bookmark management system sends a request to the media system for the additional information, and the process passes to block 1110. Otherwise, at block 1110, if the required information is included in the bookmark, then the process passes to block 1114. Block 1114 illustrates the bookmark management system adding the bookmark to a bookmark data storage system and the process ends.

Returning to block 1102, if the media system detects a communication with a bookmark download is requested, then the process passes to block 1104. In one example, a user accessing a web page interface that displays available bookmarks and the user selecting one of the bookmarks for download may trigger the bookmark download request. In another example, a bookmark download request received from a media system for searching for and downloading bookmarks meeting the request criteria may trigger the bookmark download request. In yet another example, a user may register with the bookmark management system and the user's profile may include preferences for triggering the bookmark download request. Block 1104 depicts searching the bookmark storage system for bookmarks meeting the request. Next, block 1106 illustrates selecting at least one bookmark meeting the request criteria for download to a media system or other storage location. Thereafter, block 1108 depicts downloading the selected bookmarks to the requesting media system or other system, and the process ends.

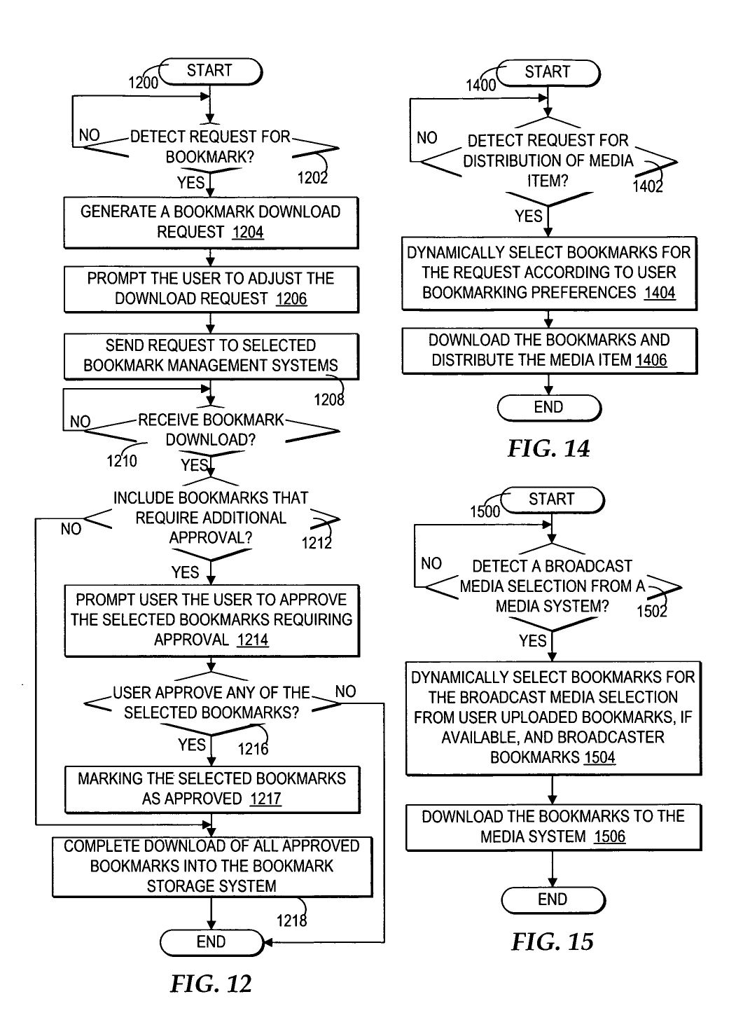

With reference now to FIG. 12, a high level logic flowchart depicts a process and program for a media system managing bookmark downloading. As illustrated, the process starts at block 1200 and thereafter proceeds to block 1202. Block 1202 depicts a determination whether a media system detects a request to download bookmarks. In one example, a user may trigger a request to download bookmarks. In another example, the media system may trigger the request to download bookmarks based on frequency settings in the user bookmark preferences. When the media system detects a request to download bookmarks, the process passes to block 1204.

Block 1204 illustrates generating a bookmark download request. Next, block 1206 depicts sending the bookmark download request to the selected bookmark management systems. Thereafter, block 1208 illustrates the media system determining whether a bookmark download is received. If the bookmark management systems respond that no bookmarks meeting the request are available, then the process passes to block 1210. Block 1210 depicts prompting the user to select alternative bookmark management systems, and the process returns to block 1206. Alternatively, the media controller may automatically select alternative bookmark management systems until a bookmark matching the download request criteria is located.

Returning to block 1208, if bookmark downloads are received, then the process passes to block 1212. Block 1212 depicts the media controller determining whether the downloaded bookmarks require user acceptance based on the user bookmarking preferences. If the downloaded bookmarks do not require user acceptance, then the process passes to block 1218. Block 1218 illustrates completing the download of all approved bookmarks into the bookmark storage system, and the process ends.

Returning to block 1212, if the downloaded bookmarks require user acceptance, then the process passes to block 1214. Block 1214 depicts prompting the user to approve each bookmark. Next, block 1216 depicts the media controller determining whether the user approves any of the bookmarks requiring approval. If the user does not approve any of the bookmarks, then the process passes to block 1218. If the user approves one or more of the bookmarks, then the process passes to block 1217. Block 1217 depicts marking all the newly approved bookmarks, and the process passes to block 1218.

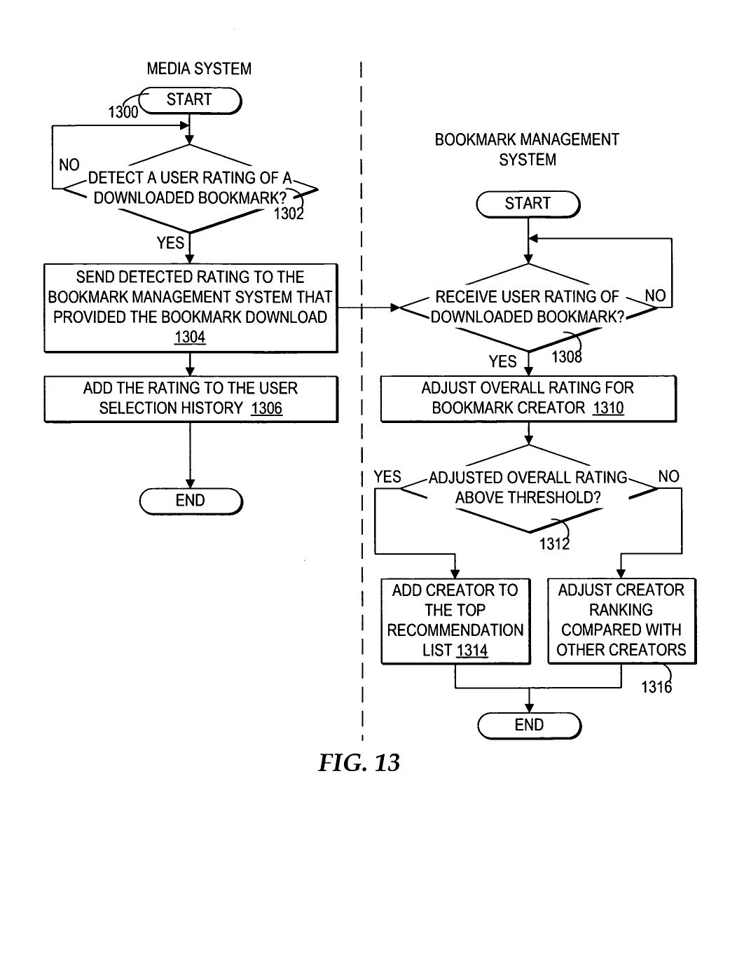

Referring now to FIG. 13, a high level logic flowchart depicts a process and program for bookmark management system compiling ratings of bookmarks. In the example, the process starts at block 1300 and thereafter proceeds to block 1302. Block 1302 depicts a determination whether the media system detects a user select a rating for a bookmark. In one example, the media player interface may include an option for a user to select a rating. If user selection of a rating is detected, then the process passes to block 1304. Block 1304 illustrates sending the rating to the bookmark management system that provided the bookmark download. Next, block 1306 depicts adding the rating to the user's bookmark selection history for use by the corpus controller is inferring user preferences and generating recommendations, and the process ends.

The bookmark management system process detects a received rating from a media system at block 1308 and the process passes to block 1310. Block 1310 depicts adjusting the overall rating for the bookmark creator based on the newly received rating. Thereafter, block 1312 depicts the bookmark management system detecting whether the overall rating for the bookmark creator now exceeds a rating threshold. If the rating does not exceeding the rating threshold, then the process ends. If the rating does exceed the rating threshold, then the process passes to block 1314. Block 1314 depicts the bookmark management system assigning the creator to a recommended list of bookmark creators, and the process ends. The bookmark management system may affix a particular graphical indication to bookmarks uploaded by the creator that the creator is on the recommended list, for example. Otherwise, at block 1312, if the rating does not exceed the rating threshold, then the process passes to block 1316. Block 1316 depicts adjusting the creator ranking when compared with other creators, and the process ends.

With reference now to FIG. 14, a high level logic flowchart illustrates a process and program for a media distributor distributing media items and bookmarks. In the example, the process starts at block 1400 and thereafter proceeds to block 1402. Block 1402 depicts a determination whether a request for a distribution of a particular media item is received. If a distribution request is received, then the process passes to block 1404. Block 1404 illustrates dynamically selecting at least one bookmark for the requested media item according to user bookmark preferences. Next, block 1406 depicts distributing the bookmarks and media item through the distribution channels available and selected, and the process ends. For example, a user may select to receive an email communication with the bookmarks as selectable text where selection of text triggers a connection to the media distributor to start download of the bookmarks.

Referring now to FIG. 15, a high level logic flowchart depicts a process and program for a media broadcaster broadcasting media items and bookmarks. In the example, the process starts at block 1500 and thereafter proceeds to block 1502. Block 1502 depicts the media broadcaster detecting a media system selection, such as an indicator that the media system is actively receiving, recording or set to record a broadcast of a media item. If the media broadcaster detects broadcast media selection from a media system, then the process passes to block 1504. Block 1504 illustrates the media broadcaster dynamically selecting bookmarks from the bookmarks specified by the media broadcaster and from any bookmarks uploaded by users. Next, block 1506 depicts downloading the selected bookmarks to the media system, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for managing a plurality of media bookmarks, comprising:
uploading, from at least one media system from among a plurality of media systems, at least one user specified bookmark designating a particular play location within a particular media item from among a plurality of media items; and
downloading, to at least one media system, said at least one user specified bookmark for said particular media item, such that at least one searchable playback location within said particular media item is specified by said particular play location within said at least one user specified bookmark.

2. The method according to claim 1, wherein said at least one user specified bookmark is specified independent of and searchable independent of at least one embedded time mark within the media item.

3. The method according to claim 1, wherein uploading furthering comprises uploading said at least one user specified bookmark to a bookmark management system for collectively managing upload and download of a plurality of bookmarks and wherein downloading further comprises downloading said at least one user specified bookmark from said bookmark management system.

4. The method according to claim 1, further comprising:
receiving, from a particular media system from among said plurality of media systems, a request for at least one bookmark identifying at least one media item characteristic;
searching a database of a plurality of separate bookmarks uploaded from a plurality of separate media systems for at least one bookmark with a characteristic matching said at least one media item characteristic;
identifying said at least one user specified bookmark matching said at least one media item characteristic; and
downloading, to said particular media system, said at least one user specified bookmark.

5. The method according to claim 1, further comprising:
receiving, from a particular media system from among said plurality of media systems, a request for distribution of said particular media item;
searching a database of a plurality of user specified bookmarks uploaded from a plurality of separate media systems for at least one bookmark for said particular media item and meeting at least one user bookmark preference;
identifying said at least one user specified bookmark for said particular media item and meeting at least one user bookmark preference; and
downloading said particular media item and said at least one specified bookmark to said particular media system.

6. The method according to claim 1, further comprising:
storing said at least one user specified bookmark in a searchable database according to at least one bookmark attribute from among a media item marked, a title, a rating, a characteristic of a location marked, a creator identifier, a generator identifier.

7. The method according to claim 1, further comprising:
receiving a communication, from said at least one media system, to upload said at least one user specified bookmark;
comparing information defining said at least one user specified bookmark with required information; and
responsive to said information definition said at least one user specified bookmark lacking at least one item in said required information, prompting said user to provide said at least one item prior to approving upload of said at least one user specified bookmark.

8. A system for managing a plurality of media bookmarks, comprising:
at least one computer system communicatively connected to a plurality of media systems for facilitating playback of digital media;
said at least one computer system for uploading from a first one of said plurality of media systems at least one user specified bookmark designating at least one playable location within at least one media items from among a plurality of media items;
said at least one computer system for storing said uploaded user specified bookmark for said media item in a searchable database of a plurality of media bookmarks; and
said at least one computer system for downloading said at least one user specified bookmark for said media item to at least one other of said plurality of media systems via said network, such that said at least one user specified bookmark specifies a searchable location during playback of said media item at said at least one other of said plurality of media systems.

9. The system according to claim 8, wherein said at least one user specified bookmark is specified independent of and searchable independent of at least one embedded time mark within the media item.

10. The system according to claim 8, said at least one computer system further comprising:
means for uploading said at least one user specified bookmark to a bookmark management system for collectively managing upload; and
means for downloading further comprises downloading said at least one user specified bookmark from said bookmark management system.

11. The system according to claim 8, said at least one computer system further comprising:
means for receiving, from a particular media system from among said plurality of media systems, a request for at least one bookmark identifying at least one media item characteristic;
means for searching said searchable database for at least one bookmark with a characteristic matching said at least one media item characteristic;
means for identifying said at least one user specified bookmark matching said at least one media item characteristic; and
means for downloading, to said particular media system, said at least one user specified bookmark.

12. The system according to claim 8, said at least one computer system further comprising:
means for receiving, from a particular media system from among said plurality of media systems, a request for distribution of said particular media item;
means for searching said searchable database for at least one bookmark for said particular media item and meeting at least one user bookmark preference;
means for identifying said at least one user specified bookmark for said particular media item and meeting at least one user bookmark preference; and
means for downloading said particular media item and said at least one specified bookmark to said particular media system.

13. The system according to claim 8, said at least one computer system further comprising:
means for storing said at least one user specified bookmark in said searchable database according to at least one bookmark attribute from among a media item marked, a title, a rating, a characteristic of a location marked, a creator identifier, a generator identifier.

14. The system according to claim 8, said at least one computer system further comprising:
means for receiving a communication, from said first media system, to upload said at least one user specified bookmark;
means for comparing information defining said at least one user specified bookmark with required information; and
means, responsive to said information definition said at least one user specified bookmark lacking at least one item in said required information, for prompting said user to provide said at least one item prior to approving upload of said at least one user specified bookmark.

15. A system for managing playback of a media item from a bookmark location, comprising:
at least one computer system communicatively connected to at least one bookmark management system for managing uploading and downloading of user specified bookmarks;
said at least one computer system for enabling a user to create at least one bookmark designating at least one playable location within a particular media item and at least one characteristic of said playable location marked specified by said user;
said at least one computer system for uploading said at least one bookmark to said at least one bookmark management system for enabling other users at other computer systems communicatively connected to said bookmark management system to search for said at least one bookmark by at least one of a title of said particular media item and said at least one characteristic specified by said user and download said at least one bookmark.

16. The system according to claim 15, further comprising said at least one computer system for downloading at least one other bookmark for said particular media item from said at least one bookmark management system and for controlling playback of said particular media item from another playable location marked by another user in said bookmark.

17. The system according to claim 16, further comprising said at least one computer system for requesting bookmarks from said at least one bookmark management system with search terms comprising at least one of trusted bookmark creators, at least one characteristic of the media item at the bookmarked location, and at least one priority setting.

18. The system according to claim 15, further comprising said at least one computer system for automatically downloading said at least one bookmark to a particular bookmark management system.

19. The system according to claim 15, further comprising said at least one computer system for adding at least one security requirement to open said at least one bookmark.

20. The system according to claim 15, further comprising said at least one computer system for detecting said user assign a rating to said at least one other bookmark and transmit said rating to said at least one bookmark management system.
